(19) United States
(12) Patent Application Publication
(10) Pub. No.: US 2015/0001889 A1
(43) Pub. Date: Jan. 1, 2015

(54) ADAPTOR FOR A FRONT BODY HINGE PILLAR

(71) Applicant: GM Global Technology Operations LLC, Detroit, MI (US)

(72) Inventors: Robert N. Saje, Shelby Township, MI (US); Keith J. Saari, Macomb Township, MI (US)

(21) Appl. No.: 13/930,553

(22) Filed: Jun. 28, 2013

(51) Int. Cl. B62D 25/04; B21J 15/02

(52) U.S. Cl. CPC B62D 25/04; B21J 15/025
USPC 296/201; 29/428; 29/525.06

(57) ABSTRACT

A product comprising a front body hinge pillar adaptor component and a method for adding an adaptor component to a standard front body hinge pillar to accommodate various styles of windshields and A-pillars.

### TECHNICAL FIELD

The field to which the disclosure generally relates to includes vehicle body structures.

### BACKGROUND

A vehicle may include front body hinge pillars.

### SUMMARY OF ILLUSTRATIVE VARIATIONS

A number of variations may include a product including: an adaptor component; wherein the adaptor component is constructed and arranged to attach to a front body hinge pillar; and wherein the adaptor component is constructed and arranged to accommodate a windshield and an A-pillar.

A number of variations may include a method including: using a first design or a first reusable casting die for a front body hinge pillar to produce a first front body hinge pillar and a second front body hinge pillar, wherein the first front body hinge pillar and the second front body hinge pillar are identical; attaching a first adaptor component to the first front body hinge pillar, wherein the first adaptor component is constructed and arranged to accommodate a first windshield and a first A-pillar; attaching a second adaptor component to the second front body hinge pillar, wherein the second adaptor component is constructed and arranged to accommodate a second windshield and a second A-pillar; wherein at least one of the first A-pillar has a different configuration than the second A-pillar or the first windshield has a different configuration than the second windshield.

Other illustrative variations within the scope of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 depicts an adaptor component according to a number of variations.

FIG. 2 depicts an adaptor component according to a number of variations.

FIG. 3 depicts a front body hinge pillar and an adaptor component according to a number of variations.

FIG. 4 depicts a close up of a front body hinge pillar and an adaptor component according to a number of variations.

FIG. 5 depicts a front body hinge pillar and an adaptor component according to a number of variations.

FIG. 6 depicts a front body hinge pillar and an adaptor component according to a number of variations.

FIG. 7 depicts a front body hinge pillar and adaptor according to a number of variations.

### DETAILED DESCRIPTION OF ILLUSTRATIVE VARIATIONS

The following description of the variations is merely illustrative in nature and is in no way intended to limit the scope of the invention, its application, or uses.

One variation may include a front body hinge pillar adaptor component.

Another variation may include a method for attaching an adaptor component to a standard front body hinge pillar to accommodate various styles of windshields and A-pillars.

A vehicle platform may include several style variations including, but not limited to, different styled upper body structures. For example, the windshield and A-pillar rake or angle may vary for each style. A front body hinge pillar 50 may be used to accommodate the windshield and the A-pillar. Accordingly, a front body hinge pillar 50 used on one style of a vehicle platform may require an upper portion 52 configuration different than another style of the same vehicle platform. Various adaptor components 54 may be used to accommodate the various upper body vehicle designs of a vehicle platform. This may allow for the use of one standard front body hinge pillar 50 and may eliminate the need to produce several different front body hinge pillars 50 each having a different upper portion 52 configuration for the different styles of the same vehicle platform.

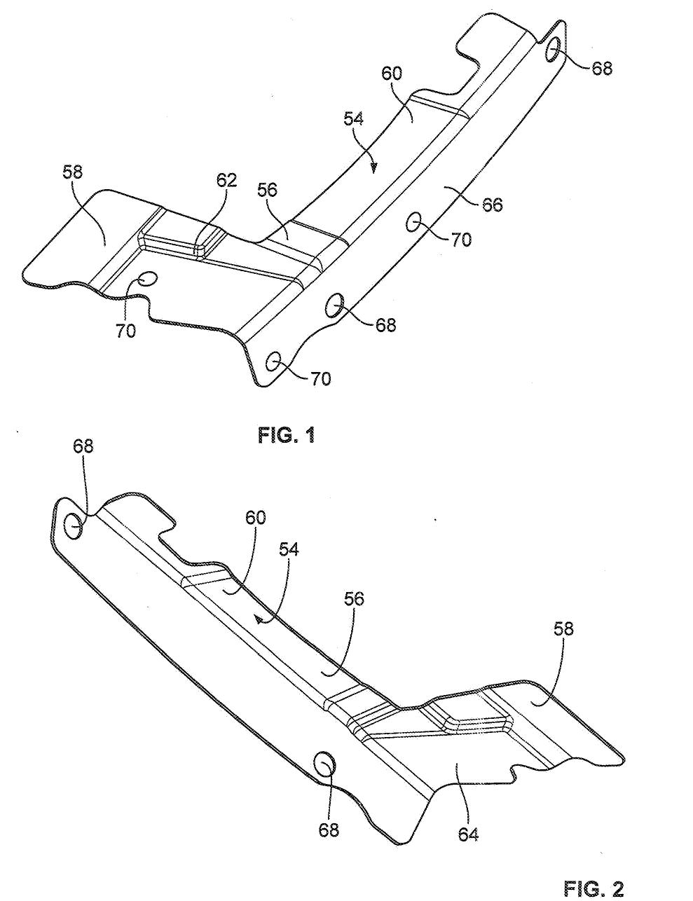

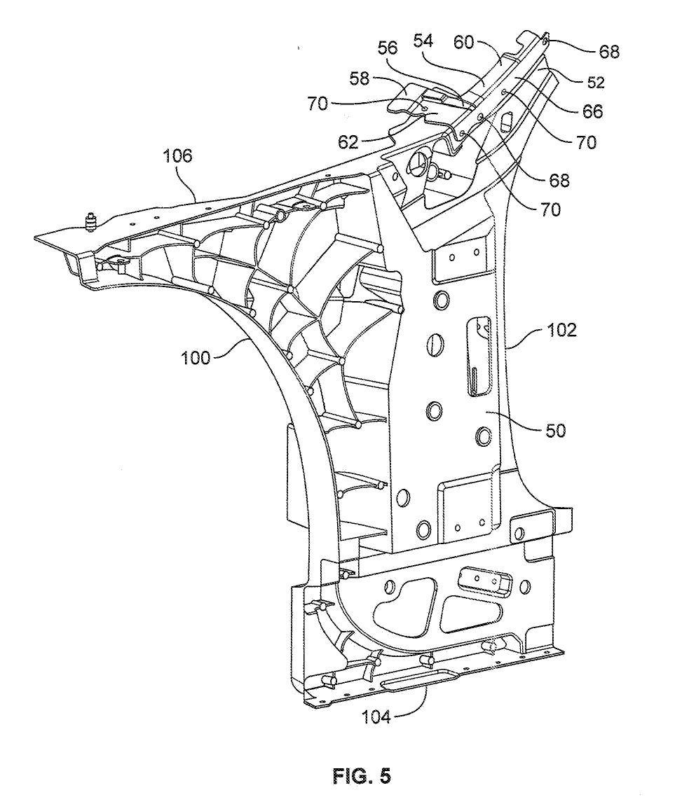

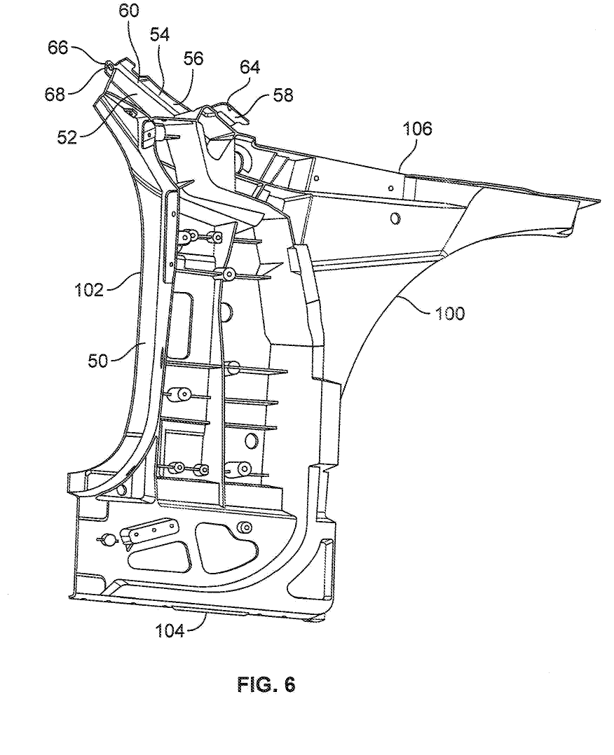

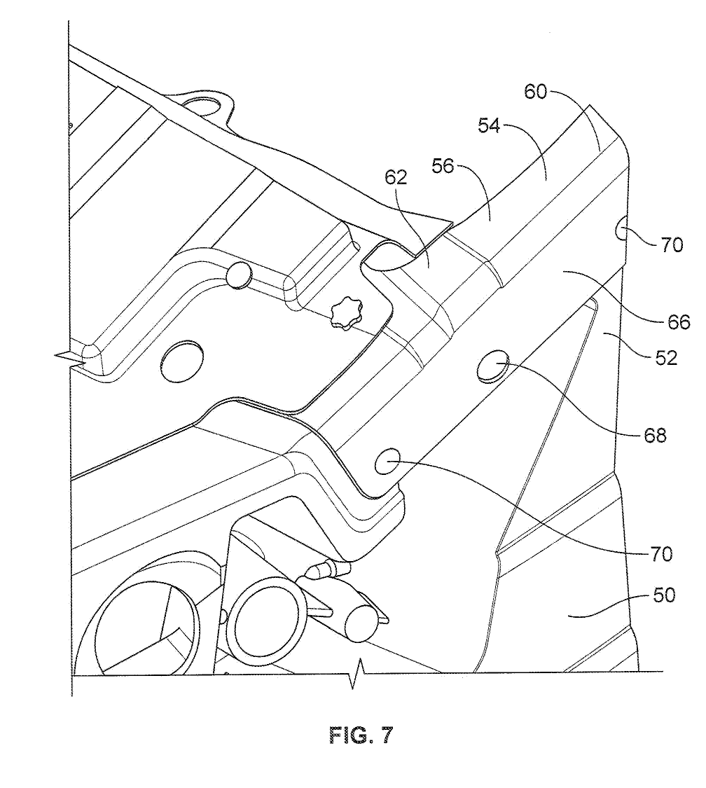

Referring to FIGS. 1-7, an adaptor component 54 may include a body 56. The body 56 may comprise a forward portion 58, a rearward portion 60, a top surface 62, a bottom surface 64, and an outer surface 66, for example as illustrated in FIGS. 1-2. The forward portion 58 and rearward portion 60 may be constructed and arranged to mate with a front body hinge pillar 50 and may also be constructed and arranged to accommodate a windshield and A-pillar. The outer surface 66 of the body 56 may be bent downwards and approximately perpendicular to the top surface 62. The adaptor component 54 may also include at least one hole 68 which may be located on the outer surface 66 of the body 56 of the adaptor component 54. The at least one hole 68 may be used as a datum feature in the assembly of the vehicle.

In a number of variations the front body hinge pillar 50 may include a first arcuate or curved portion 100 constructed and arranged to define at least in part a vehicle wheel well, a bottom edge 104, a top edge 106 and a second arcuate or curved portion 102 constructed and arrange to define at least in part a door well.

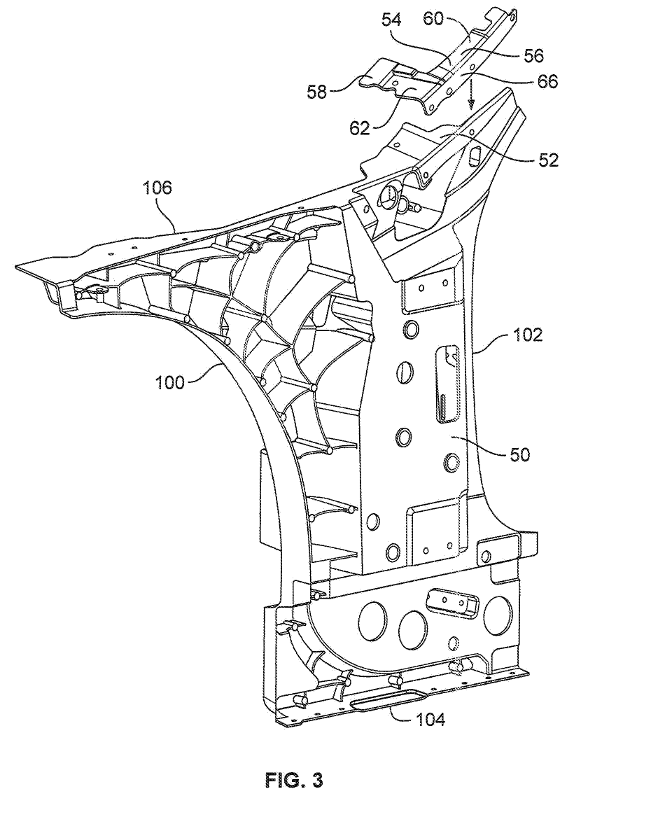

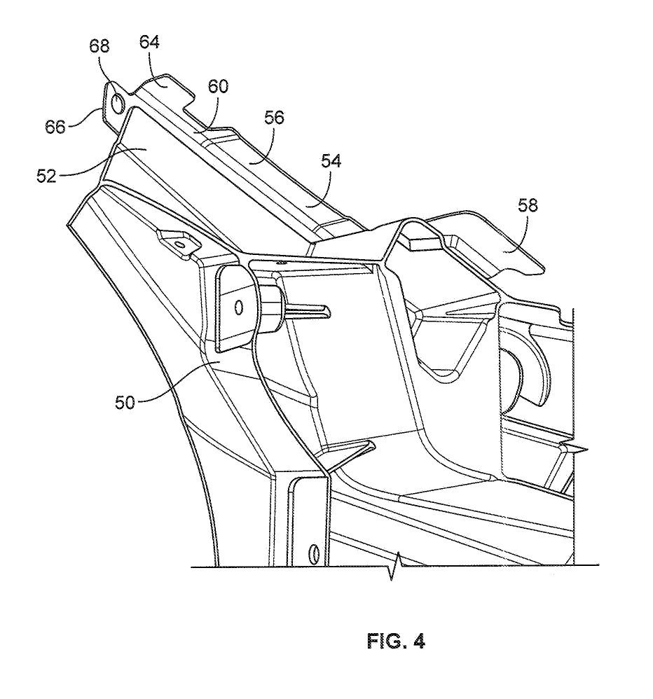

The adaptor component 54 may be attached to the upper portion 52 of the front body hinge pillar 50, for example as shown in FIGS. 3-7. The adaptor component 54 may be formed in any of a number of ways including, but not limited to, stamping. In one variation, the adaptor component 54 may comprise steel and the front body hinge pillar 50 may comprise an aluminum high pressure die cast. A structural adhesive may be placed on the bottom surface 64 of the adaptor component 54 and placed onto the upper portion 52 of the front body hinge pillar 50. The adaptor component 54 may then be further attached to the aluminum front body hinge pillar 50 via self-piercing rivets 70. The self-piercing rivets 70 may be applied to the forward portion 58 and the outer surface 66 of the body 56, for example as illustrated in FIG. 1.

In another variation, the adaptor component 54 may comprise aluminum and the front body hinge pillar 50 may comprise an aluminum high pressure die cast. In this variation, the adaptor component 54 may be spot welded to the front body hinge pillar 50.

A number of variations may include a method including: using a first design or a first reusable casting die for a front body hinge pillar to produce a first front body hinge pillar and a second front body hinge pillar, wherein the first front body hinge pillar and the second front body hinge pillar are identical; attaching a first adaptor component to the first front body hinge pillar, wherein the first adaptor component is constructed and arranged to accommodate a first windshield and a first A-pillar; attaching a second adaptor component to the first front body hinge pillar, wherein the second adaptor component is constructed and arranged to accommodate a first windshield and a second A-pillar; wherein at least one of the first A-pillar has a different configuration than the second A-pillar or the first windshield has a different configuration than the second windshield.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a product comprising: an adaptor component; wherein the adaptor component is constructed and arranged to attach to a front body hinge pillar; and wherein the adaptor component is constructed and arranged to accommodate a windshield and an A-pillar.

Variation 2 may include a product as set forth in Variation 1 wherein the adaptor component includes a body; and wherein the body includes a rearward portion, a forward portion, a top surface, a bottom surface, and an outer surface.

Variation 3 may include a product as set forth in any of

Variations 1-2 wherein the outer surface is approximately perpendicular to the bottom surface.

Variation 4 may include a product as set forth in any of

Variations 1-3 wherein the adaptor component includes at least one hole.

Variation 5 may include a product as set forth in any of

Variations 1-4 wherein at least one hole is located on the outer surface of the adaptor component.

Variation 6 may include a product as set forth in any of

Variations 1-5 wherein the adaptor component is attached to the front body hinge pillar.

Variation 7 may include a product as set forth in any of

Variations 1-6 wherein the adaptor component comprises steel and wherein the front body hinge pillar comprises aluminum.

Variation 8 may include a product as set forth in any of

Variations 1-7 wherein the adaptor component is attached to the front body hinge pillar using at least one self-piercing rivet.

Variation 9 may include a product as set forth in any of

Variations 1-6 wherein the adaptor component comprises aluminum and wherein the front body hinge pillar comprises aluminum.

Variation 10 may include a product as set forth in any of

Variations 1-6 and 9 wherein the adaptor component is attached to the front body hinge pillar using spot welding.

Variation 11 may include a product as set forth in any of

Variations 1-10 wherein the adaptor component is stamped.

Variation 12 may include a product as set forth in any of

Variations 1-11 wherein the front body hinge pillar is high pressure die cast.

Variation 13 may include a method comprising: using a first design or a first reusable casting die for a front body hinge pillar to produce a first front body hinge pillar and a second front body hinge pillar, wherein the first front body hinge pillar and the second front body hinge pillar are identical; attaching a first adaptor component to the first front body hinge pillar, wherein the first adaptor component is constructed and arranged to accommodate a first windshield and a first A-pillar; attaching a second adaptor component to the second front body hinge pillar, wherein the second adaptor component is constructed and arranged to accommodate a second windshield and a second A-pillar; wherein at least one of the first A-pillar has a different configuration than the second A-pillar or the first windshield has a different configuration than the second windshield.

Variation 14 may include a method as set forth in Variation 13 wherein both the first A-pillar has a different configuration than the second A-pillar and the first windshield has a different configuration than the second windshield.

Variation 15 may include a method as set forth in any of

Variations 13-14 wherein the adaptor component includes a body; and wherein the body includes a rearward portion, a forward portion, a top surface, a bottom surface, and an outer surface.

Variation 16 may include a method as set forth in Variation 15 wherein the outer surface is approximately perpendicular to the bottom surface.

Variation 17 may include a method as set forth in any of

Variations 13-16 wherein the first adaptor component includes at least one hole.

Variation 18 may include a method as set forth in any of

Variations 13-17 wherein attaching the first adaptor component to the first front body hinge pillar comprises spot welding the first adaptor component to the first front body hinge pillar.

Variation 19 may include a method as set forth in any of

Variations 13-18 wherein attaching the first adaptor component to the first front body hinge pillar comprises using at least one self-piercing rivet to attach the first adaptor component to the first front body hinge pillar.

Variation 20 may include a method as set forth in any of

Variations 13-19 wherein the first adaptor component is stamped and the first front body hinge pillar is high pressure die cast.

The above description of select variation within the scope of the invention is merely illustrative in nature and, thus, variations or variants thereof are not to be regarded as a departure from the spirit and scope of the invention.

1. A product comprising:
an adaptor component;
wherein the adaptor component is constructed and arranged to attach to a front body hinge pillar; and
wherein the adaptor component is constructed and arranged to accommodate a windshield and an A-pillar.

2. The product of claim 1 wherein the adaptor component includes a body; and
wherein the body includes a rearward portion, a forward portion, a top surface, a bottom surface, and an outer surface.

3. The product of claim 2 wherein the outer surface is approximately perpendicular to the bottom surface.

4. The product of claim 1 wherein the adaptor component includes at least one hole.

5. The product of claim 4 wherein the at least one hole is located on the outer surface of the adaptor component.

6. The product of claim 1 wherein the adaptor component is attached to the front body hinge pillar.

7. The product of claim 6 wherein the adaptor component comprises steel and wherein the front body hinge pillar comprises aluminum.

8. The product of claim 7 wherein the adaptor component is attached to the front body hinge pillar using at least one self-piercing rivet.

9. The product of claim 6 wherein the adaptor component comprises aluminum and wherein the front body hinge pillar comprises aluminum.

10. The product of claim 9 wherein the adaptor component is attached to the front body hinge pillar using spot welding.

11. The product of claim 1 wherein the adaptor component is stamped.

12. The product of claim 1 wherein the front body hinge pillar is high pressure die cast.

13. A method comprising:
using a first design or a first reusable casting die for a front body hinge pillar to produce a first front body hinge pillar and a second front body hinge pillar, wherein the first front body hinge pillar and the second front body hinge pillar are identical;
attaching a first adaptor component to the first front body hinge pillar, wherein the first adaptor component is constructed and arranged to accommodate a first windshield and a first A-pillar;
attaching a second adaptor component to the second front body hinge pillar, wherein the second adaptor component is constructed and arranged to accommodate a second windshield and a second A-pillar;
wherein at least one of the first A-pillar has a different configuration than the second A-pillar or the first windshield has a different configuration than the second windshield.

14. A method as set forth in claim 13 wherein both the first A-pillar has a different configuration than the second A-pillar and the first windshield has a different configuration than the second windshield.

15. The method of claim 13 wherein the adaptor component includes a body; and
wherein the body includes a rearward portion, a forward portion, a top surface, a bottom surface, and an outer surface.

16. The method of claim 15 wherein the outer surface is approximately perpendicular to the bottom surface.

17. The method of claim 13 wherein the first adaptor component includes at least one hole.

18. The method of claim 13 wherein attaching the first adaptor component to the first front body hinge pillar comprises spot welding the first adaptor component to the first front body hinge pillar.

19. The method of claim 13 wherein attaching the first adaptor component to the first front body hinge pillar comprises using at least one self-piercing rivet to attach the first adaptor component to the front body hinge pillar.

20. The method of claim 13 wherein the first adaptor component is stamped and the first front body hinge pillar is high pressure die cast.
